(19) United States
(12) Patent Application Publication
(10) Pub. No.: US 2020/0136364 A1
(43) Pub. Date: Apr. 30, 2020

(54) SHORT-CIRCUIT-PROOF BUSBAR ASSEMBLY

(71) Applicant: Siemens Aktiengesellschaft, 80333 München (DE)

(72) Inventors: NICOLAI LESCOW, Osnabriick (DE); HEIKO RABUS, Geyern (DE)

(73) Assignee: Siemens Aktiengesellschaft, 80333 München (DE)

(21) Appl. No.: 16/606,561

(22) PCT Filed: Apr. 13, 2018
(86) PCT No.: PCT/EP2018/059509

§ 371 Date: Oct. 18, 2019

(30) Foreign Application Priority Data
Apr. 20, 2017 (EP) 17167323.9

(51) Int. Cl. H02G 5/02; H02M 7/00

(52) U.S. Cl. CPC H02G 5/025; H02M 7/003

(57) ABSTRACT

A busbar assembly includes first, second, and third busbars at least partly arranged in parallel relation, wherein the first and second busbars are offset to each other such that a first straight line which does not pass through the second busbar is formed perpendicularly to a longer extension of the first busbar, the first and third busbars are offset to each other such that a second straight line which does not pass through the third busbar is formed perpendicularly to the longer extension of the first busbar, and the second and third busbars are not offset to each other such that a third straight line which is formed perpendicularly to the longer extension of the second busbar passes through the third busbar. The busbar assembly is configured at least partly mirror-symmetrical to a plane running through the first busbar and parallel to the longer extension of the first busbar.

The invention relates to a busbar assembly having at least a first and a second busbar, wherein the busbars are at least partly arranged parallel to one another. The invention also relates to a converter having a busbar assembly of this kind.

Busbars are used for a low-induction and low-loss flow of electric current. Busbars are used in particular in converters in order, for example, to electrically contact the semiconductors. For trouble-free operation the intermediate circuit barring is designed with busbars which are arranged in a busbar package. A low-induction construction can be implemented therewith.

It is precisely in the event of a short-circuit that the busbars and their attachments are subject to a high load due to the forces that then occur. No damage to the busbar assembly may occur in this case.

Previously, the busbar package was designed as a laminated low-induction barring in relation to the intermediate circuit. The busbars are located very close to each other in this case in order to keep the inductance as low as possible and are designed with a large surface in order to keep the mechanical forces low. The busbars, such as positive bars, average potential bars, negative bars of a three-level converter are each provided with an insulating film (lamination) since the air gaps between the bare copper bars are not adhered to in accordance with the standard specifications. The three bars are bundled with large-surface supports by way of glass fiber reinforced (GFR) plastics material panels to form bar packages which are so stiff that they can absorb high short-circuit forces. The otherwise closed lamination is interrupted at the connecting points of the bars. The bars are canted at these locations such that they adopt sufficient spacings from each other. The necessary air gaps and creep distances can be adhered to thereby. The electrical and mechanical connection to the neighboring bar package is made by way of a large number of screw joints.

The invention is based on the object of disclosing a busbar assembly having improved short-circuit behavior.

The object is achieved by a busbar assembly comprising at least one first, second and third busbar, wherein the busbars are at least partly arranged parallel to one another, wherein the first busbar and the second busbar are offset relative to each other such that at least one first straight line which does not pass through the second busbar can be formed perpendicularly to a longer extension of the first busbar, wherein the first busbar and the third busbar are offset relative to each other such that at least one second straight line which does not pass through the third busbar can be formed perpendicularly to the longer extension of the first busbar, wherein the second busbar and the third busbar are not offset relative to each other such that all third straight lines which can be formed perpendicularly to the longer extension of the second busbar pass through the third busbar, wherein with respect to the busbars, the busbar assembly is at least partly mirror symmetrical to a plane which runs through the interior of the first busbar and parallel to a longer extension of the first busbar. The object is also achieved by a converter having a busbar assembly of this kind.

Further advantageous embodiments of the invention are disclosed in the dependent claims.

The invention is based on the knowledge that the mechanical and electrical properties may be positively influenced by the construction. From mechanical perspectives the busbars, for example three busbars in the case of a three-level converter (positive bar, average potential bar, negative bar) should be spaced apart as far as possible so the short-circuit forces are as small as possible. From an electrotechnical perspective the busbars, for example a positive bar, average potential bar, negative bar here too, should, by contrast, be as close together as possible so the inductance of the barring is as small as possible. Due to the offset arrangement of a first busbar with respect to a second and optionally also with respect to a third busbar, the conflict, described above, between mechanical and electrical optimization can be easily and unexpectedly resolved.

In contrast to the known solutions, which are dealt with, for example, in the standard DIN EN 60865-1 (VDE 0103), the individual busbars as sub-conductors are not arranged in a layered manner one behind or one above the other and instead the bars affected by the short-circuit are offset relative to each other and are advantageously held by highly-loadable supports. A short-circuit is produced for example between positive bar and average potential bar or between negative bar and average potential bar of a busbar assembly having three busbars, due to a simple fault in just one component.

In general it can be assumed that the cross-section of a busbar is elongate in design. This is the case, for example, with a rectangular shape or an elliptical shape. This cross-section then has a longer extension, in other words the longer edges or side of the rectangle, or the longer axis of the ellipse as a connection of the two main vertices, and a shorter extension, in other words the shorter edge, in other words, side, of the rectangle, or the shorter axis of the ellipse as a connection of the two secondary vertices. Owing to the at least partly parallel course, it is irrelevant at which point of the cross-section the busbar assembly is viewed. With a construction that is not offset, a straight line perpendicular to the longer extension passes through the busbars that are not offset. If the straight line passes through just one of the busbars with the same length of the longer extension, the busbars are offset relative to each other. An offset assembly is referred to as soon as only one such straight line can be formed. If a first busbar, for example the middle of three busbars, is arranged offset, then this is displaced in the direction of the longer extension, in other words along the longer extension, of the busbar. To achieve a clear improvement in the electrical and mechanical properties a displacement by 10 mm, for example, has proven to be particularly advantageous if the busbars have a rectangular cross-section of 10 mm×100 mm. The different busbars can have an identical or different direction of the longer extension in this case. The behavior of the busbar in the event of a short-circuit, in which large forces act on the busbars owing to the current level, can be significantly improved thereby. This arrangement makes it possible, with relatively low inductances, to reduce the resulting short-circuit forces. The inductance is still within the admissible limit values in this case and required space as well as accessibility of the connecting faces (assembly/maintenance) are comparatively good.

This assembly has a large number of advantages. Fuses, for example, which quickly switch off a short-circuit current that occurs, can be omitted therefore and inadmissible forces can be avoided thereby or at least are able to act only for a short time. A converter can, for example, be designed without fuses on the basis of this busbar assembly. A fuse-less converter concept can be achieved with the busbar assembly therefore. This concept is much more compact and can be implemented with less expense compared to a design having fuses. Compared to a standard solution according to DIN EN 60865-1 (VDE 0103), owing to the much lower forces between the busbars, most of the supports between the busbars can be omitted, moreover. Similarly, the inventive busbar assembly is much more compact, in particular at the connecting points. Furthermore, adherence to requirements in respect of air gaps and creep distances is much easier.

Further advantages consist in that the active forces are distributed in the direction of the longer extension and in the direction of the shorter extension of the busbars. These forces can be controlled better thereby. At the same time, the higher resistance moment of the busbars, such as, for example, of a copper bar, can be better used in the direction of the longer extension, and this leads to a reduction in the short-circuit currents. From the mechanics perspective, the division into the two directions of extension of the busbar cross-section is not necessarily advantageous. However, the advantage comes about in that a force component in the direction of the higher resistance moment occurs in favor of a reduction of the force components in the direction of the smaller resistance moment. Best of all, however, would be just one force in the direction of the greater resistance moment, although this conflicts with the compromise with the electrotechnology.

Furthermore, inexpensive copper rod material can be used which has lower strength requirements. A cost-intensive lamination with insulating film can be omitted due to the larger spacings. The support can be reduced owing to the greater spacings and offset arrangement. This manifests itself in particular in a lower number of supports between the busbars. Ease of assembly/maintenance is increased by the offset arrangement of the first bar, for example the average potential bar of a busbar assembly having three busbars. The busbars can be joined together by fewer screw joints owing to the smaller forces. As already mentioned, the construction requires only a relatively small space requirement and the design is particularly robust in respect of susceptibility to faults.

The fault-prone, flexible connection to the capacitors (soldered-in thin membranes on the laminated bar) previously customary in converters and which are sometimes very sensitive can be replaced by simple, stable, flexible copper bars as a result of the novel arrangement.

This design is simple and inexpensive to implement, moreover. Applicable standard limit values and spacings can be easily adhered to with this construction. Furthermore, the construction is also much less susceptible to faults due to flashovers owing to contamination, adverse environmental conditions (for example also vermin). Due to the simple construction, failures owing to careless assembly, as are sometimes known from the prior art with layered busbar packages, are less probable since there is not a large number of screws at sometimes hard-to-access positions and on assembly of which insulating films can be damaged.

The busbar assembly has a third busbar, with the first busbar and the third busbar being arranged offset relative to each other. There are at least three busbars in this embodiment. This embodiment is used in particular with a busbar assembly having three busbars. A typical example of this is the DC barring of a 3-level converter. Here, the first and second busbars are offset relative to each other and the first and third busbars are offset relative to each other. Since in the case of a conventionally simple fault a short-circuit occurs only between positive bar and average potential bar or negative bar and average potential bar, it has proven to be particularly advantageous to design the first bar as an average potential bar since it is offset with respect to the other two bars.

The centers of the cross-sections of the individual busbars form a triangle as a result of the offset arrangement. It has proven to be particularly expedient if the cross-sections form an equilateral triangle since then the short-circuit behavior is independent of whether it occurs on the positive or the negative bar. Furthermore, the construction is symmetrical with respect to the potentials and therewith also the operating behavior.

The second busbar and the third busbar are not offset relative to each other. The arrangement without offset means that they are not offset relative to each other in the direction of the longer extension. Since short-circuits are relatively unlikely to occur between the first and the second busbars, when these are positive and negative bars, these bars can also not be offset relative to each other. Furthermore, the forces in the event of a short-circuit tend to be low due to the spacing between the bars. Since these bars are not located in a commutation circuit, the requirements in respect of low-induction behavior are lower. The arrangement without offset can ensure a sufficiently low-induction construction for the second and third busbars with simultaneously good short-circuit behavior.

In an advantageous embodiment of the invention the busbars have the same cross-section. Currents in the same order of magnitude can be transmitted thereby. Short-circuit currents can be absorbed in the same way by all busbars. Furthermore, the inductive behavior of the busbars in relation to each other is the same, and this ensures behavior that is independent of the switching state of the converter.

In a further advantageous embodiment of the invention the busbars have an essentially rectangular cross-section, wherein the busbars offset relative to each other in pairs are offset in the direction of a longer edge, in other words the longer side, of the rectangular cross-section. The cross-section of the busbars often differs at its corners from the rectangular shape. The edges of the busbar are rounded, for example, in order to avoid high field strengths in this region. This property is accommodated by the wording “essentially rectangular”.

The intermediate circuit barring is designed, for example, as a composite package with positive intermediate circuit bar located in the direction of the converter back wall, negative intermediate circuit bar located therebehind at a spacing of, for example, 90 mm, and average potential bar arranged centrally thereover. The cross-sections of the individual bars are, for example, 10 mm×100 mm=1,000 mm². The offset average potential bar does not just increase the effective spacing between the different busbars, resulting in a reduction in the short-circuit force, but the force is divided in one components in the direction of the longer extension (long side edge of the rectangular cross-section) and shorter extension (short side edge of the rectangular cross-section), wherein, due to the rectangular cross-section of the copper bar of, for example, 10 mm×100 mm, the much higher resistance moment of the copper rod material is used in the direction of the longer extension. It is therefore possible to increase the greatest-occurring mean spacing of adjacent support points.

In an advantageous embodiment the first busbar is arranged between a first plane and a second plane. The first and second planes extend perpendicularly to the cross-sectional area and parallel to the longer edge of the cross-section of the second and third busbars respectively. The longer edge results as the longer lateral line of the rectangular cross-section of the busbar. A particularly compact construction can be achieved thereby. The forces that occur with this assembly in the event of a short-circuit are especially low, so the busbars and any supports can be produced particularly inexpensively. Low-strength copper material can be used for the busbars, and this is much less expensive.

In a further advantageous embodiment of the invention the busbars are oriented relative to each other in such a way that the longer edge of the rectangular cross-section of the respective busbars are parallel to each other. This arrangement also leads to a further reduction in the forces that occur in the event of a short-circuit and, for the reasons mentioned above, to a further reduction in material costs. At the same time, a three-level converter having this construction has an electrically symmetrical structure, resulting in symmetrical operating behavior.

In a further advantageous embodiment of the invention at least two of the busbars are mechanically connected together by at least one support, wherein the support is electrically insulating in design. A complete and large-surface connection between the busbars can be omitted since the forces that occur no longer require this in the event of a short-circuit and only a number of supports is used for positioning of the busbars. In the event of a short-circuit these supports absorb the resultant forces and should therefore have a stable design. Due to the low short-circuit currents, a large-surface arrangement of supporting means between the busbars can be omitted since the existing strength of the copper, even with low-strength copper bars, in conjunction with a few supports is enough to prevent deformations of supports and busbars.

It is thereby possible, with a number of supports that remains within cost limits, to withstand the high short-circuit forces without deformations of the copper bars occurring.

The supports additionally have an insulating material to electrically insulate the busbars, which are mechanically connected to the supports, from each other.

In a further advantageous embodiment of the invention the support has the form of a cuboid. A parallel and mirror-symmetrical construction of the busbar assembly can be easily achieved with this embodiment. For this, the cuboid shape, in particular when it has a solid design, provides the possibility of absorbing a sufficiently high volume of forces, which act on the busbar in the event of a short-circuit.

In a further advantageous embodiment of the invention the support comprises a highly loadable laminate according to DIN EN 60893-3-2, in particular the HGW material EP-GC 202. Owing to its high strength and insulating properties this material is ideally suitable for use in the support. It is relatively inexpensive to obtain commercially, moreover.

In the event of a short-circuit the supports have to absorb very high forces. This is possible as a result of the choice of the highly loadable HGW material EP-GC 202 (DIN EN 60893-3-2) in conjunction with a highly stable form. The air gaps between the supports of the individual phases and the creep distances must be adhered to in the arrangement of the screws between screw joint and copper bar.

In a further advantageous embodiment of the invention the support is designed in such a way as to absorb without destruction the forces occurring with a short-circuit current flowing in the busbars between the busbars connected to the support. A short-circuit current is a current which goes beyond the stable current carrying capacity of the busbar. Therefore, a short-circuit current would inadmissibly heat a busbar if it were to flow in the busbar for a long time. Short-circuit currents are determined for example by the voltages present in the system. Similarly, the electrical components can influence the level of the short-circuit current. The short-circuit current is mathematically determined for the application, for example in a converter. The supports then have to have a correspondingly high strength in relation to their mechanical load-bearing capacity.

In a further advantageous embodiment of the invention the support is designed for a value of the short-circuit current of more than 100 kA. With short-circuit currents of this order of magnitude the forces are so high that the busbar assembly has a particularly positive effect on the resulting forces. In this case the busbar assembly delivers a great financial advantage compared to a layered construction.

In a further advantageous embodiment of the invention the converter has IGCT semiconductor components. In the event of a fault, IGCT components can fail and thereby form a short-circuit in the system. Therefore protection in the event of a short-circuit is much more important for a converter having IGCT semiconductor elements than for converters with alternative semiconductor elements. For this reason use of the busbar assembly for this type of semiconductor components is particularly advantageous since costly damage in the event of a short-circuit can be avoided here.

The invention will be described and explained in more detail below with reference to the exemplary embodiments illustrated in the figures, in which:

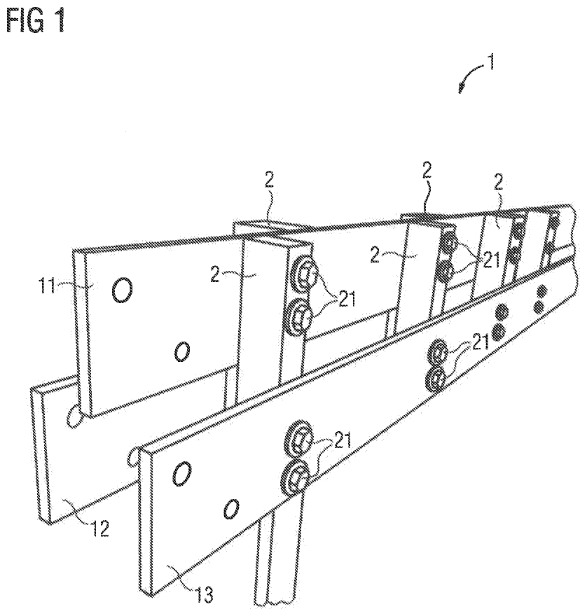

FIG. 1 shows a busbar assembly,

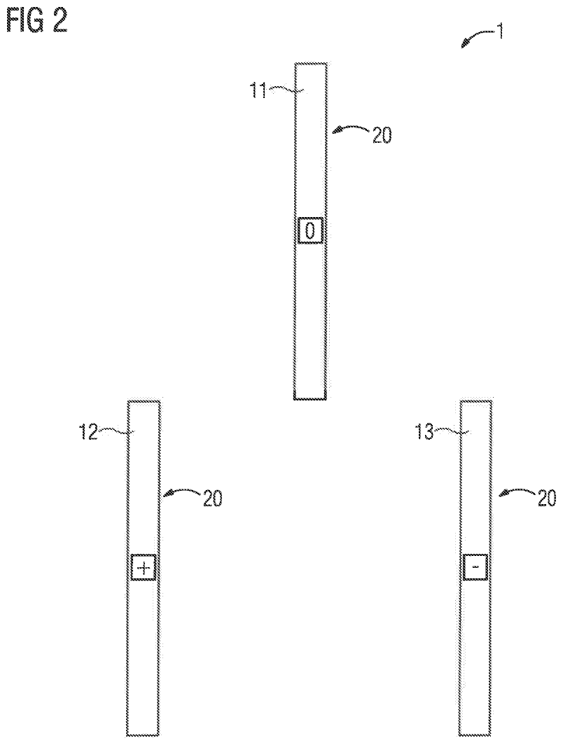

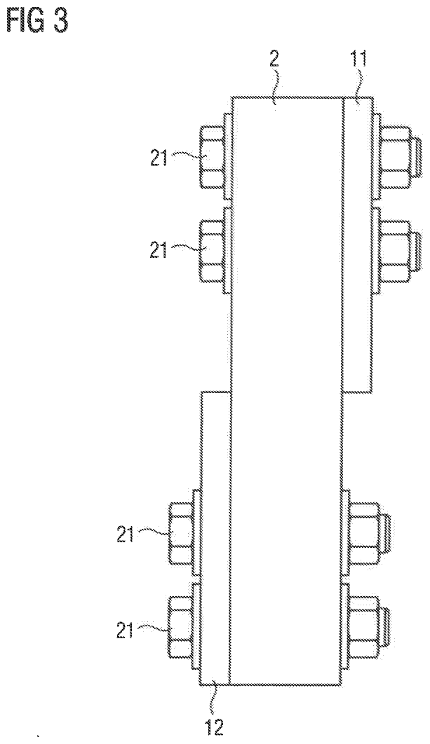

FIG. 2, FIG. 3 show cross-sections through a busbar assembly,

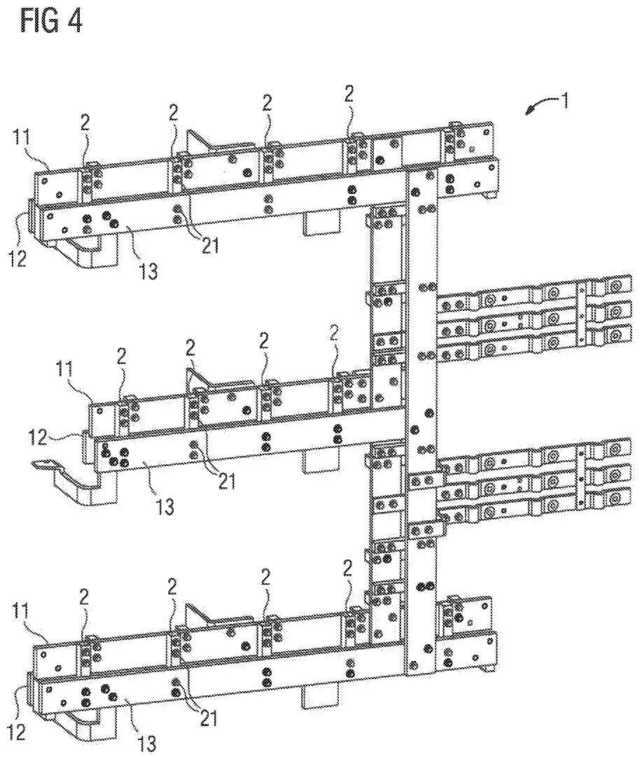

FIG. 4 shows busbar assembly for a converter.

FIG. 1 shows the perspective representation of a busbar assembly 1. This busbar assembly 1 has three busbars 11, 12, 13. The first busbar 11 is offset with respect to the second and third busbars 12, 13 as this busbar 11 is slightly higher than the other busbars 12, 13. As already mentioned, the design of the first busbar 11 as an average potential bar is therefore particularly advantageous since a short-circuit can occur between this bar and the positive bar or the negative bar even with a simple component fault. The busbars 11, 12, 13 are mechanically connected by supports 2. The supports 2 each connect two of the busbars 11, 12, 13 together mechanically. This advantageously occurs by means of screw joints 21. These supports 2 are provided on the busbars 11, 12, 13 so as to be distributed over the length of the busbars 11, 12, 13.

FIG. 2 shows the cross-section through a converter assembly 1 having three busbars 11, 12, 13. It can clearly be seen that the first busbar 11 is offset with respect to the second and third busbars 12, 13 as the first busbar is offset in the direction of the long edge 20 of the rectangular cross-section, in other words longitudinally. In this exemplary embodiment the first busbar 11 carries the average potential, identified by “0”, the second busbar 12 the positive potential, identified by “+” and the third busbar 13 the negative potential, identified by “−”. In this arrangement the centers of the cross-sectional areas form an equilateral triangle. This favors the operating behavior of a converter having a busbar assembly of this kind since the busbar assembly has a symmetrical construction between positive potential and average potential as well as negative potential and average potential.

FIG. 3 shows the section through two busbars 11, 12 at the location of a support 2. To avoid repetition reference is made to the description relating to FIGS. 1 and 2 as well as to the reference numerals introduced there. The first busbar 11 and the second busbar 12 are offset relative to each other. The support 2 is used to fix the position of the two busbars 11, 12 relative to each other. To be able to absorb the forces in the event of a short-circuit as well, the support 2 should have a highly stable form. The busbars 11, 12 are attached by means of screw joints 21 to the support 2.

FIG. 4 shows a busbar assembly 1 for a three-phase converter. This is a three-level converter since this busbar assembly 1 has three busbars 11, 12, 13 and therefore three direct current potentials. The phases of the converter 3 arranged one above the other can clearly be seen. Each of these phases is connected to one or more semiconductor module(s) (not shown here), which enables a connection of the respective alternating current-side output to one of the direct current potentials. To avoid repetition reference is made to the description relating to FIGS. 1 to 3 as well as to the reference numerals introduced there.

In summary, the invention relates to a busbar assembly having at least one first and one second busbar, wherein the busbars are at least partly arranged parallel to one another. To improve the short-circuit behavior it is proposed that the first busbar and the second busbar are offset relative to each other. The invention also relates to converters having a busbar assembly of this kind.

1.-11. (canceled)

12. A busbar assembly, comprising:
first, second and third busbars arranged at least partly in parallel relation to one another, with the first and second busbars being offset relative to each other such that a first straight line which does not pass through the second busbar is formed perpendicularly to a longer extension of a cross-section of the first busbar, with the first and third busbars being offset relative to each other such that a second straight line which does not pass through the third busbar is formed perpendicularly to the longer extension of the cross-section of the first busbar, with the second and third busbars being not offset relative to each other such that a third straight line which is formed perpendicularly to a longer extension of a cross-section of the second busbar passes through the third busbar, said busbar assembly being configured with respect to the first, second and third busbars at least partly mirror symmetrical to a plane which runs through an interior of the first busbar and parallel to the longer extension of the first busbar; and
an electrically insulating support configured to mechanically connect together two of the first, second and third busbars.

13. The busbar assembly of claim 12, wherein the first, second and third busbars have a same cross-section.

14. The busbar assembly of claim 12, wherein the first, second and third busbars have a substantially rectangular cross-section, with the busbars that are offset relative to each other in pairs being offset in a direction of a longer edge of the rectangular cross-section.

15. The busbar assembly of claim 14, wherein the first, second and third busbars are oriented relative to each other in such a way that the longer edges of the rectangular cross-section of the busbars are parallel to each other.

16. The busbar assembly of claim 12, wherein the support has the form of a cuboid.

17. The busbar assembly of claim 12, wherein the support comprises a highly loadable laminate according to DIN EN 60893-3-2.

18. The busbar assembly of claim 12, wherein the laminate is of HGW material EP-GC 202.

19. The busbar assembly of claim 12, wherein the support is configured to absorb without destruction a force between the two of the first, second and third busbars that are connected to the support, as a result of a short-circuit current flowing in the busbars.

20. The busbar assembly of claim 19, wherein the support is configured for a value of the short-circuit current of more than 100 kA.

21. A converter, comprising a busbar assembly, said busbar assembly comprising first, second and third busbars arranged at least partly in parallel relation to one another, with the first and second busbars being offset relative to each other such that a first straight line which does not pass through the second busbar is formed perpendicularly to a longer extension of a cross-section of the first busbar, with the first and third busbars being offset relative to each other such that a second straight line which does not pass through the third busbar is formed perpendicularly to the longer extension of the cross-section of the first busbar, with the second and third busbars being not offset relative to each other such that a third straight line which is formed perpendicularly to a longer extension of a cross-section of the second busbar passes through the third busbar, said busbar assembly being configured with respect to the first, second and third busbars at least partly mirror symmetrical to a plane which runs through an interior of the first busbar and parallel to the longer extension of the first busbar, and an electrically insulating support configured to mechanically connect together two of the first, second and third busbars.

22. The converter of claim 21, further comprising a IGCT semiconductor component.

23. The converter of claim 21, wherein the first, second and third busbars have a same cross-section.

24. The converter of claim 21, wherein the first, second and third busbars have a substantially rectangular cross-section, with the busbars that are offset relative to each other in pairs being offset in a direction of a longer edge of the rectangular cross-section.

25. The converter of claim 24, wherein the first, second and third busbars are oriented relative to each other in such a way that the longer edges of the rectangular cross-section of the busbars are parallel to each other.

26. The converter of claim 21, wherein the support has the form of a cuboid.

27. The converter of claim 21, wherein the support comprises a highly loadable laminate according to DIN EN 60893-3-2.

28. The converter of claim 21, wherein the laminate is of HGW material EP-GC 202.

29. The converter of claim 21, wherein the support is configured to absorb without destruction a force between the two of the first, second and third busbars that are connected to the support, as a result of a short-circuit current flowing in the busbars.

30. The converter of claim 29, wherein the support is configured for a value of the short-circuit current of more than 100 kA.
